(19) United States
(12) Patent Application Publication
(10) Pub. No.: US 2026/0031096 A1
(43) Pub. Date: Jan. 29, 2026

(54) DETERMINING SPEED CHANGE RATIO FOR AUDIO SAMPLES

(71) Applicants: Beijing Zitiao Network Technology Co., Ltd., Beijing (CN); Lemon Inc., Grand Cayman (KY)

(72) Inventors: Jing Jiang, Beijing (CN); Rongrong Liu, Culver City, CA (US)

(21) Appl. No.: 18/787,432

(22) Filed: Jul. 29, 2024

(51) Int. Cl. G10L 25/51; G10L 25/30

(52) U.S. Cl. CPC G10L 25/51; G10L 25/30

(57) ABSTRACT

A computing system including one or more processing devices configured to receive a first audio sample and a second audio sample. The one or more processing devices determine a speed change ratio between the first audio sample and the second audio sample at least in part by extracting first audio features from the first audio sample and second audio features from the second audio sample. Determining the speed change ratio further includes computing a similarity matrix including between the set of first audio features and the set of second audio features. Determining the speed change ratio further includes identifying peak points in the similarity matrix and identifying one or more peak lines. Determining the speed change ratio further includes computing the speed change ratio based at least in part on respective slopes of the one or more peak lines. The one or more processing devices output the speed change ratio.

### BACKGROUND

On video sharing platforms, many videos include user-modified music. This music may be modified in a variety of ways, such as by changing a singer or instrumentalist, remixing the music, modifying the rhythm, or modifying the tempo. Some modified music uploaded to a video sharing platform utilizes multiple such techniques concurrently or at different portions of the video.

Music identification is sometimes performed on videos uploaded to a video sharing platform. For example, music identification may be used to identify videos with the same music track. Additionally or alternatively, music identification may be performed to generate a track label that is displayed to a user, such as in a video description header or footer or in an overview of a playlist. However, music identification techniques often fail to correctly determine that two audio samples are the same song, as discussed below, and thus opportunities exist to improve upon current music identification techniques.

### SUMMARY

According to one aspect of the present disclosure, a computing system is provided, including one or more processing devices configured to receive a first audio sample and a second audio sample. The one or more processing devices are further configured to determine a speed change ratio between the first audio sample and the second audio sample at least in part by extracting a set of first audio features from the first audio sample and a set of second audio features from the second audio sample. Determining the speed change ratio further includes computing a similarity matrix including a plurality of similarity values between the set of first audio features and the set of second audio features. Determining the speed change ratio further includes identifying a plurality of peak points in the similarity matrix. Determining the speed change ratio further includes identifying one or more peak lines that each include two or more of the peak points. Determining the speed change ratio further includes computing the speed change ratio based at least in part on one or more respective slopes of the one or more peak lines. The one or more processing devices are further configured to output the speed change ratio.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system at which a speed change ratio between a first audio sample and a second audio sample is determined, according to one example embodiment.

FIG. 2 schematically shows an example similarity matrix, according to the example of FIG. 1.

FIGS. 3A-3B schematically show the computing system when a candidate peak set search is performed to identify one or more peak lines in the similarity matrix, according to the example of FIG. 1.

FIG. 4A schematically shows the computing system when heuristic multi-line fitting is performed to identify the one or more peak lines, according to the example of FIG. 1.

FIG. 4B schematically shows example candidate peak maps and an additional candidate endpoint, according to the example of FIG. 4A.

FIG. 4C schematically shows additional computing processes configured to be performed at the computing system during heuristic multi-line fitting, according to the example of FIG. 4A.

FIG. 5 schematically shows the computing system when speed change identification is performed on a first audio sample included in a user-uploaded video received from a client computing device, according to the example of FIG. 1.

FIG. 6A shows a flowchart of a method for use with a computing system to determine a speed change ratio, according to the example of FIG. 1.

FIGS. 6B-6C show additional steps of the method of FIG. 6A that may be performed in some examples when identifying one or more peak lines.

FIG. 7 shows a schematic view of an example computing environment in which the computing system of FIG. 1 may be instantiated.

### DETAILED DESCRIPTION

Some existing methods of identifying modified music use music fingerprints, also known as acoustic fingerprints, to detect whether one music track is a sped-up or slowed-down version of another. Music fingerprints are a condensed digital summary of an audio sample (i.e., digitized acoustic waveform) that are deterministically generated using music fingerprint algorithms. The music fingerprints include hashable characteristics from the original track and are identifiable with linear time complexity. For example, shift-invariant music fingerprints may be used to determine whether two tracks are related. A similarity comparison algorithm may compare the fingerprints and determine that two tracks are possibly related if a similarity score produced by the algorithm is above a threshold value. On the other hand, two tracks that produce a similarity score below a threshold would be deemed unrelated. A technical problem is presented when one of or both of two otherwise similar tracks are distorted in a way that fools the similarity algorithm into outputting a false negative for similarity of the tracks.

Accordingly, a class of existing similarity algorithms has been developed that are robust to such distortion. These existing algorithms compute a distortion ratio between an original music track and a modified music track. From the shift-invariant music fingerprints, an average distortion of the modified music track in time can be determined, and this average distortion can be used to compute a speed change ratio of the modified music track relative to the original music track. The speed change ratio may be used to determine whether the modified music track is a speed-modified version of the original music track.

However, such music speed change detection algorithms can frequently produce unreliable results when, in addition to having its tempo changed, the modified music track has also been subjected to other alterations. For example, a track that has been remixed as well as speed-modified may be difficult to identify using the conventional fingerprinting approaches described above. Since speed modification and remixing of music tracks are frequently used in conjunction with each other (e.g., on social media platforms where users often generate videos with backing music that is sped up or slowed down relative to an original track and may also include other audio in the mix, and also in some niche genres of music such as nightcore or vaporwave), conventional techniques of detecting speed-modified tracks may fail to identify many instances of sped-up and slowed-down music.

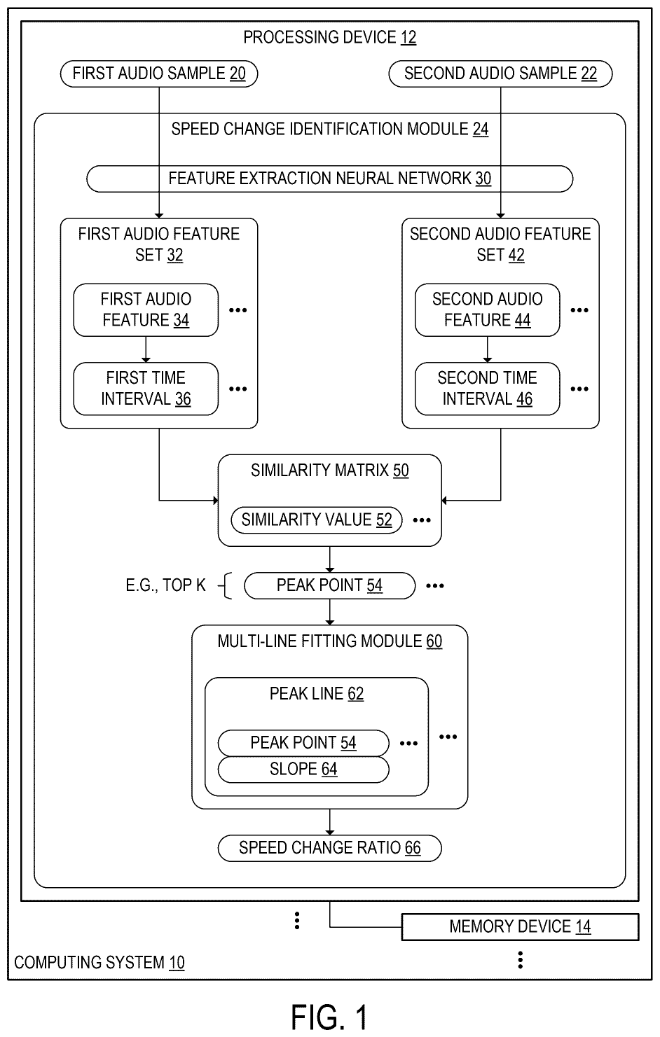

The devices and methods discussed below are provided in order to address these challenges in speed-altered music identification. FIG. 1 schematically shows a computing system 10 including one or more processing devices 12 and one or more memory devices 14. The one or more processing devices 12 may, for example, include one or more central processing units (CPUs), graphics processing units (GPUs), tensor units, application-specific integrated circuits (ASICs), and/or other types of processing devices 12. The one or more memory devices 14 may include volatile memory and non-volatile storage.

In some examples, the computing system 10 is distributed across a plurality of physical computing devices, whereas in other examples, the one or more processing devices 12 and the one or more memory devices 14 are included in a single physical computing device. In examples in which the computing system 10 is distributed across multiple physical computing devices, those physical computing devices may, for example, include one or more networked computing devices located at a data center. The multiple physical computing devices may additionally or alternatively include one or more client computing devices (e.g., smartphones or desktop computers) that are configured to communicate with one or more server computing devices.

As shown in the example of FIG. 1, the one or more processing devices 12 are configured to receive a first audio sample 20 and a second audio sample 22. The first audio sample and the second audio sample 22 may be music tracks. Other audio elements, such as speech layered on top of background music, may also be included in the first audio sample 20 and/or the second audio sample 22 in some examples. The first audio sample 20 may, for example, be the audio component of a user-uploaded video, and the second audio sample 22 may be a previously stored comparison track retrieved from the one or more memory devices 14. The one or more processing devices 12 are further configured to input the first audio sample 20 and the second audio sample 22 into a speed change identification module 24 at which the one or more processing devices 12 are configured to determine a speed change ratio 66 between the first audio sample 20 and the second audio sample 22.

Determining the speed change ratio 66 includes extracting a set 32 of first audio features 34 from the first audio sample 20 and a set 42 of second audio features 44 from the second audio sample 22. For example, the first audio features 34 and the second audio features 44 may be constant-Q transform (CQT) features or variable-Q transform (VQT) features. The first audio features 34 may be associated with respective timestamps that indicate first time intervals 36 within the first audio sample 20 from which those first audio features 34 were extracted. Similarly, the second audio features 44 may be associated with respective timestamps that indicate second time intervals 46 within the second audio sample 22 from which the second audio features 44 were extracted. The first audio feature set 32 may be expressed as a T₁×D matrix, where T₁ is the number of first time intervals 36 in the first audio sample 20 and D is a feature extractor output dimensionality. Similarly, the second audio feature set 42 may be a T₂×D matrix, where T₂ is the number of second time intervals 46 in the second audio sample 22.

In some examples, the one or more processing devices 12 may be configured to extract the set 32 of first audio features 34 and the set 42 of second audio features 44 at a feature extraction neural network 30. The feature extraction neural network 30 may, for example, use a convolutional neural network (CNN) architecture, a transformer network architecture, a combination thereof, or some other neural network architecture.

Computing the speed change ratio 66 at the speed change identification module 24 further includes computing a similarity matrix 50 between the set 32 of first audio features 34 and the set 42 of second audio features 44. The similarity matrix 50 includes a plurality of similarity values 52, which may, for example, be a cosine similarity value. Other similarity metrics may alternatively be used to compute the similarity values 52.

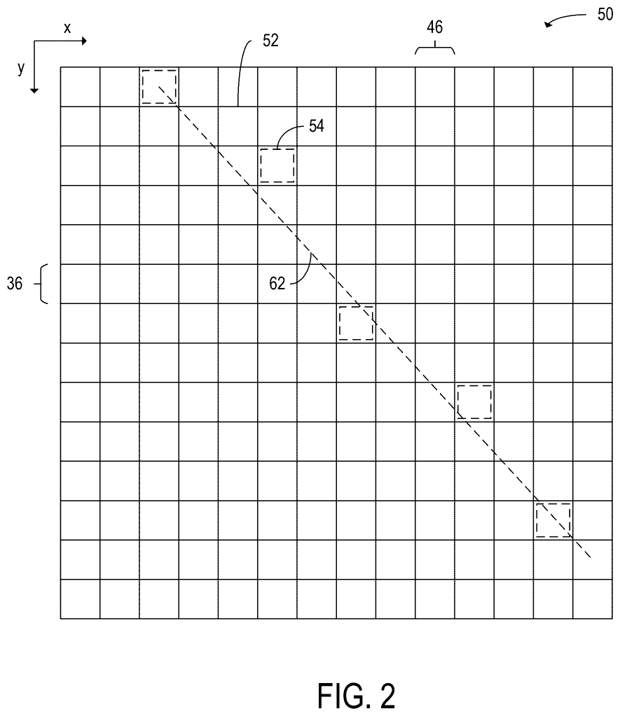

An example similarity matrix 50 is schematically depicted in FIG. 2, according to one example. The similarity matrix 50 includes a respective similarity value 52 for each timestamp pair (x, y), where x is a first time interval 36 and y is a second time interval 46. Thus, the similarity matrix 50 has dimensions T₁×T₂. Although the similarity matrix 50 of FIG. 2 is a square matrix, the similarity matrix 50 may have a different shape in examples in which the first audio sample 20 and the second audio sample 22 differ in length.

Returning to the example of FIG. 1, the one or more processing devices 12 are further configured to identify a plurality of peak points 54 in the similarity matrix 50. In some examples, the one or more processing devices 12 may be configured to identify the plurality of peak points 62 as the K highest similarity values 52 included in the similarity matrix 50, where K is a predefined peak count. For example, the one or more processing devices 12 may be configured to select the 150 highest similarity values 52 as the peak points 54.

The one or more processing devices 12 are further configured to execute a multi-line fitting module 60 to identify one or more peak lines 62 in the similarity matrix 50. In some examples, a plurality of peak lines 62 may be present in the similarity matrix 50. For example, the similarity matrix 50 may include multiple peak lines due to patterns in the first audio sample 20 and the second audio sample 22 that repeat in time, such as a repeated rhythm, harmonic pattern, or section of a song. Due to the potential presence of multiple valid peak lines 62, multi-line fitting is performed instead of single-line linear regression.

The one or more peak lines 62 each include two or more of the peak points 54. In addition, each peak line 62 has a respective slope 64. In some examples, as discussed in further detail below, the peak line 62 may be specified by a pair of the peak points 54 that are indicated as endpoints. In other examples, the peak line 62 may be an estimated line of best fit for a set of more than two peak points 54. FIG. 2 shows an example peak line 62 approximated for a set of five peak points 54.

The one or more processing devices 12 are further configured to compute the speed change ratio 66 based at least in part on the one or more respective slopes 64 of the one or more peak lines 62. For example, the speed change ratio 66 may be computed as mean of the respective slopes 64 of the one or more peak lines 62.

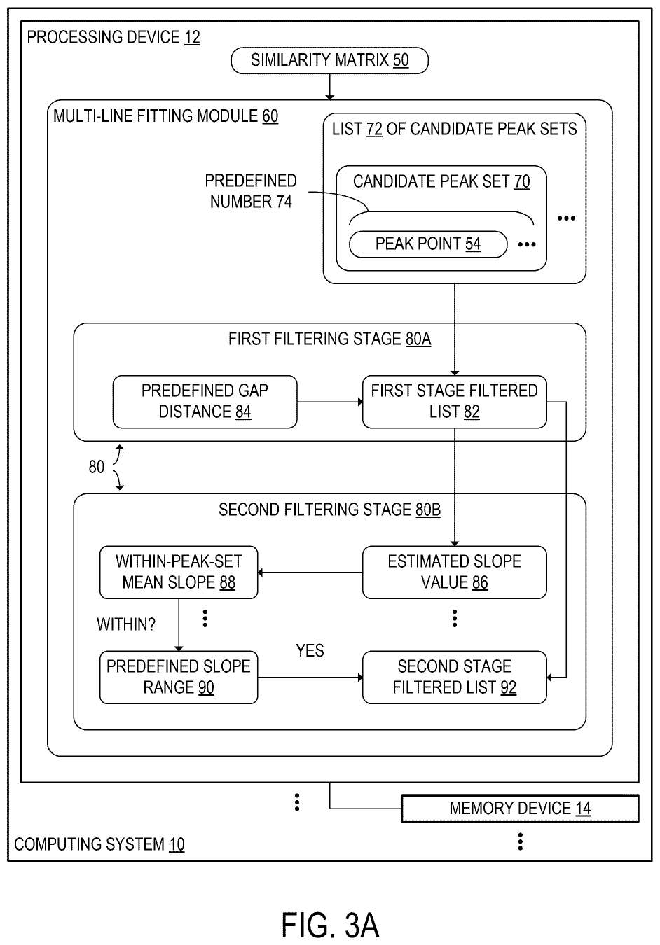

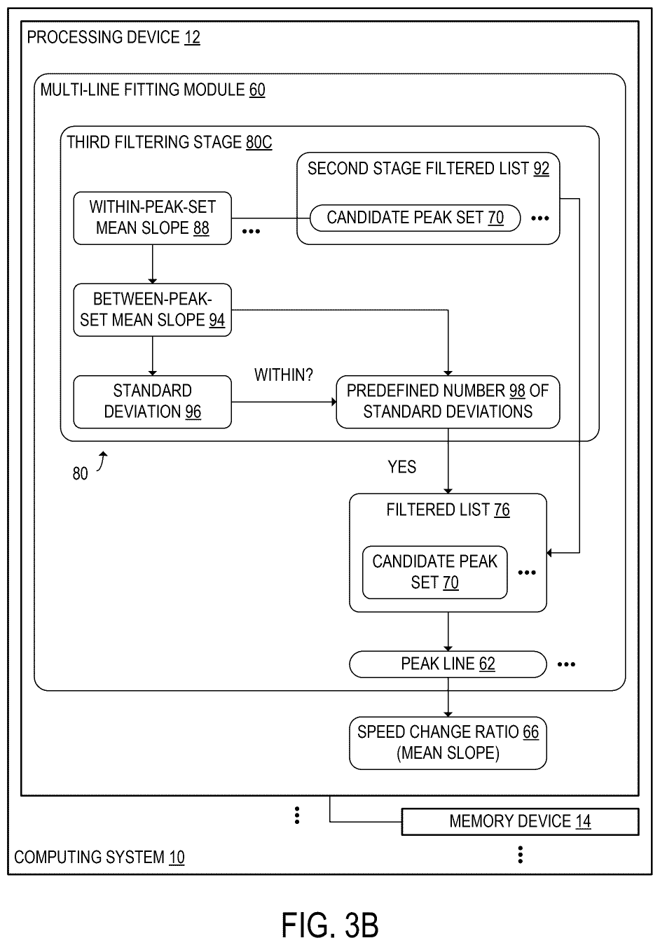

FIGS. 3A-3B schematically show the computing system 10 in an example in which the one or more processing devices 12 are configured to perform candidate peak set search at the multi-line fitting module 60 in order to determine the speed change ratio 66. In the example of FIGS. 3A-3B, the one or more processing devices 12 are configured to identify the one or more peak lines 62 at least in part by selecting a list 72 of candidate peak sets 70. The candidate peak sets 70 each include a predefined number 74 of the peak points 54. For example, each candidate peak set 70 may include five peak points 54. Some other number of peak points 54 may be selected in other examples. The one or more processing devices 12 may be configured to compute the candidate peak sets 70 via random or pseudorandom selection from the set of peak points 54.

The one or more processing devices 12 may be further configured to compute a filtered list 76 of the candidate peak sets 70 over a plurality of filtering stages 80. As shown in the example of FIGS. 3A-3B, the one or more processing devices 12 are configured to perform a first filtering stage 80A, a second filtering stage 80B, and a third filtering stage 80C. The one or more processing devices 12 may be further configured to compute the speed change ratio 66 as a mean slope value of the candidate peak sets 70 included in the filtered list 76.

In the first filtering stage 80A, computing the filtered list 76 may include computing a first stage filtered list 82 as a subset of the list 72 of candidate peak sets 70. For each of the candidate peak sets 70 included in the first stage filtered list 82, the peak points 54 included in that candidate peak set 70 are spaced apart from each other by at least a predefined gap distance 84. During the first filtering stage 80A, the one or more processing devices 12 may accordingly be configured to determine the distances between pairs of the peak points 54 included in the candidate peak set 70 and check whether those distances are greater than the predefined gap distance 84.

Subsequently to the first filtering stage 80A, the one or more processing devices 12 may be further configured to perform a second filtering stage 80B. In the second filtering stage 80B, computing the filtered list 76 may further include, for each of the candidate peak sets 70 included in the first stage filtered list 82, computing a plurality of estimated slope values 86 between pairs of the peak points 54 included in that candidate peak set 70. The estimated slope values 86 are estimated values of the slope 64 of a peak line 62 through the set of peak points 54 included in the corresponding candidate peak set 70.

The second filtering stage 80B further includes determining whether a within-peak-set mean slope 88 of the estimated slope values 86 is within a predefined slope range 90. For example, the predefined slope range 90 may be a range from 0.5 to 2. Thus, in such examples, the one or more processing devices 12 may be configured to estimate whether the first audio sample 20 is within a range from half the speed of the second audio sample 22 to double the speed of the second audio sample 22. Other predefined slope ranges 90 may be used in other examples. The second filtering stage 80B may further include adding the candidate peak set 70 to a second stage filtered list 92 if the within-peak-set mean slope 88 is within the predefined slope range 90. The one or more processing devices 12 may accordingly filter out candidate peak sets 70 that have unusually high or low within-peak-set mean slopes 88 and that are therefore likely to be false positives.

In a third filtering stage 80C of the plurality of filtering stages 80, computing the filtered list 76 may further include computing a between-peak-set mean slope 94 of the within-peak-set mean slopes 88 of the candidate peak sets 70 included in the second stage filtered list 92. The third filtering stage 80C may further include computing a standard deviation 96 of the within-peak-set mean slopes 88 of the candidate peak sets 70 included in the second stage filtered list 92. The one or more processing devices 12 may be further configured to select, as the filtered list 76, the candidate peak sets 70 included in the second stage filtered list 92 that have respective within-peak-set mean slopes 88 within a predefined number 98 of standard deviations 96 from the between-peak-set mean slope 94. The predefined number 98 of standard deviations 96 may, for example, be two standard deviations 96. Accordingly, in the third filtering stage 80C, the one or more processing devices 12 may be configured to remove outliers from the second stage filtered list 92. The speed change ratio 66 may then be computed as the mean slope of the filtered list 76 from which the outliers have been removed.

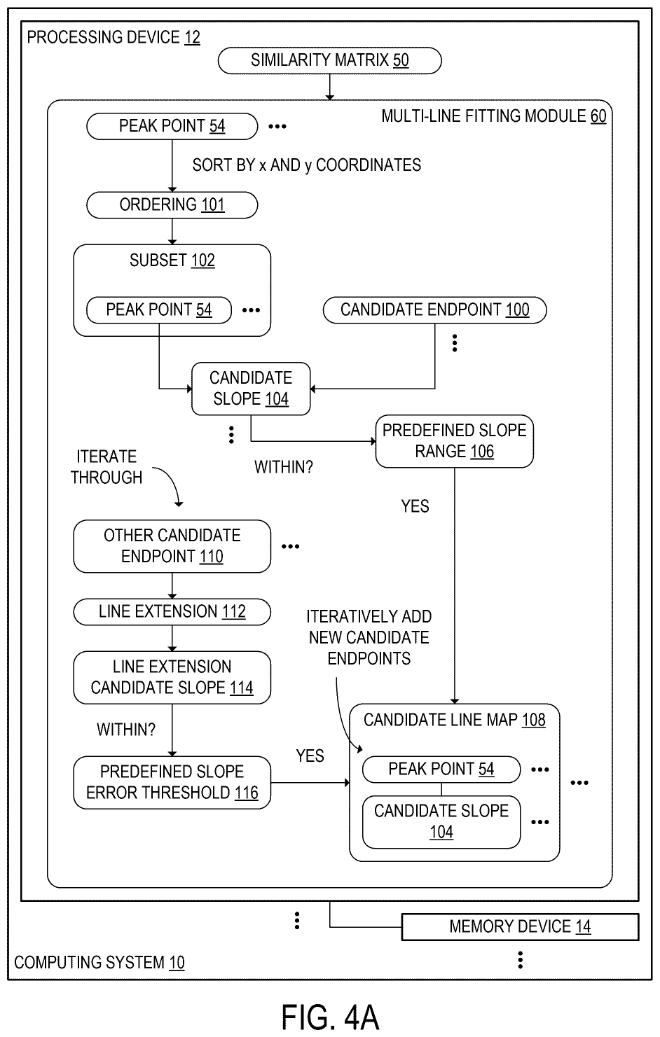

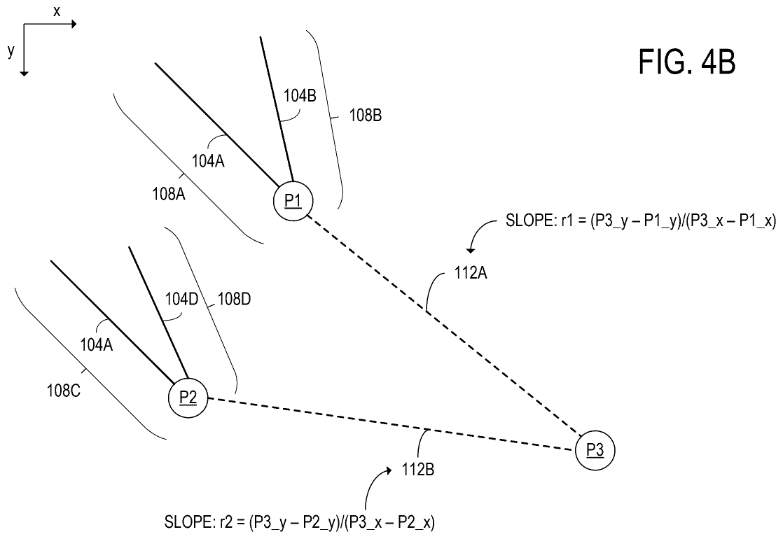

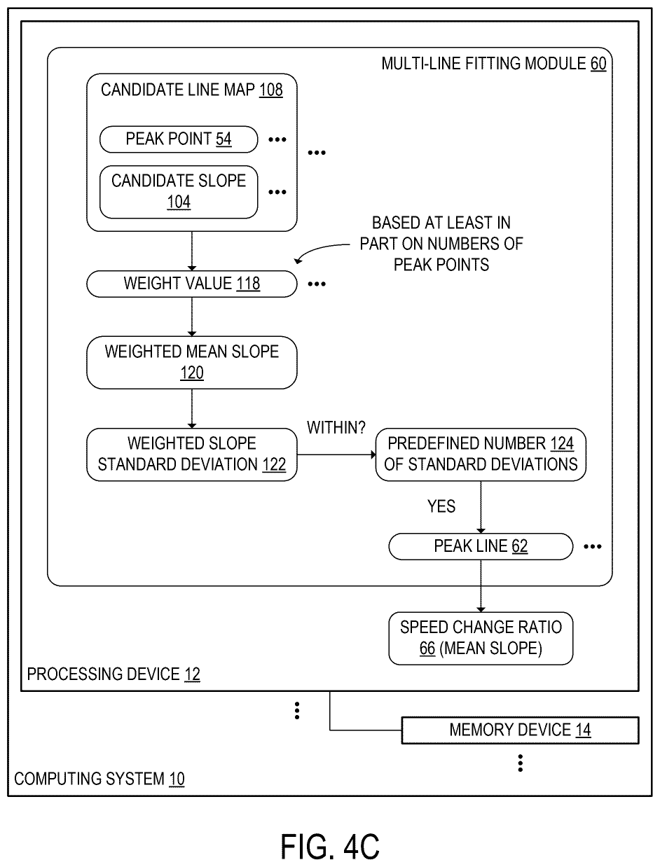

FIG. 4A schematically shows the computing system 10 when heuristic multi-line fitting is instead performed at the multi-line fitting module 60 to identify the one or more peak lines 62. In some examples, as a preliminary step to the computation of the one or more peak lines 62, the one or more processing devices 12 are configured to sort the peak points 54 according to their x and y coordinates. The peak points 54 may, for example, be sorted into an ordering 101 that runs from the top row to the bottom row of the similarity matrix 50, and from left to right within the rows.

In the example of FIG. 4A, for each peak point 54 included in a subset 102 of the plurality of peak points 54, one or more processing devices 12 are further configured to compute respective candidate slopes 104 between the peak point 54 and a plurality of candidate endpoints 100. The candidate endpoints 100 are also included among the plurality of peak points 54. The subset 102 of the plurality of peak points 54 may, for example, be the peak points 54 included in an upper left half of the similarity matrix 50. In other examples, the subset 102 may include all the peak points 54 other than a final peak point 54 in the top-left-to-bottom-right ordering 101.

For each of the candidate endpoints 100, the one or more processing devices 12 may be further configured to determine whether the candidate slope 104 is within a predefined slope range 106. In some examples, as in the example of FIGS. 3A-3B, the predefined slope range 106 may be [0.5, 2]. In other examples, some other predefined slope range 106 may be used. If the candidate slope 104 is within the predefined slope range 106, the one or more processing devices 12 may be further configured to adding the candidate slope 104 and the candidate endpoint 100 to a candidate line map 108. Each of the candidate line maps 108 identified at the multi-line fitting module 60 may be defined by its candidate endpoint 100 and its candidate slope 104. The candidate line map 108 stores endpoint-slope pairs that may be aggregated to compute the one or more peak lines 62, as discussed in further detail below.

Identifying the one or more peak lines 62 may further include, for each of the candidate line maps 108, computing a respective line extension 112 for each of a plurality of other candidate endpoints 110. The line extension 112 is located between the candidate endpoint 100 of the candidate line map 108 and the other candidate endpoint 110. The candidate endpoint 100 used as a starting point of the line extension 112 may be a most recently computed candidate endpoint 100 of the candidate line map 108.

For each line extension 112, identifying the one or more peak lines 62 may further include determining whether the line extension 112 has a respective line extension candidate slope 114 within a predefined slope error threshold 116 of the candidate slope 104 computed between the peak point 54 and the candidate endpoint 100. If the line extension 112 has a respective line extension candidate slope 114 within the predefined slope error threshold 116 of the candidate slope 104, the one or more processing devices 12 are further configured to add the other candidate endpoint 110 to the candidate line map 108. In addition, the line extension candidate slope 114 of the line extension 112 may be stored in the candidate line map 108 in association with the peak point 54. In examples in which the other candidate endpoint 110 is added, the other candidate endpoint 110 may be treated as the candidate endpoint 100 in a subsequent iteration in which another candidate endpoint 110 is checked. The candidate line map 108 is therefore iteratively constructed as a set of peak points 54 that have previously been candidate endpoints 100 of the candidate line map 108 or that are the current candidate endpoint 100.

FIG. 4B shows an example of peak points P1, P2, and P3. The peak points P1 and P2 are candidate endpoints 100 of two candidate line maps 108 each, with the peak point P1 being a candidate endpoint of the candidate line maps 108A and 108B and the peak point P2 being a candidate endpoint of the candidate line maps 108C and 108D. The candidate line maps 108A and 108C have the same candidate slope 104A in the example of FIG. 4C, whereas the candidate line maps 108B and 108D have different candidate slopes 104B and 104D, respectively.

In the example of FIG. 4B, the one or more processing devices 12 are further configured to determine whether to add the peak point P3 to any of the candidate line maps 108 as another candidate endpoint 110. In order to make this determination, the one or more processing devices 12 are configured to compute respective candidate slopes r1 and r2 of respective line extensions 112A and 112B, where the line extension 112A is located between P1 and P3 and the line extension 112B is located between P2 and P3. The candidate slopes are computed as:

$$r 1 = \frac{( P {3}_{y} - P {1}_{y} )}{( P {3}_{x} - P {1}_{x} )}$$

$$and$$

$$r 2 = \frac{( P {3}_{y} - P {2}_{y} )}{( P {3}_{x} - P {2}_{x} )}$$

The one or more processing devices 12 are further configured to determine whether the candidate slopes r1 and r2 are within the predefined slope range 106. In the example of FIG. 4B, the candidate slope r1 is within the predefined slope range 106, whereas the candidate slope r2 is not.

The one or more processing devices 12 are further configured to compare the candidate slopes r1 and r2 to the candidate slopes 104A, 104B, and 104D when determining whether to add the peak point P3 to the candidate line maps 108. The candidate slope r1 is within the predefined slope error threshold 116 relative to the candidate slope 104A but not the candidate slopes 104B and 104D. Accordingly, the one or more processing devices 12 are configured to add the peak point P3 to the candidate line map 108A but not to the candidate line maps 108B, 108C, or 108D.

FIG. 4C shows additional steps that may be performed at the multi-line fitting module 60 in order to determine the speed change ratio 66. According to the example of FIG. 4C, subsequently to iterating through the plurality of candidate endpoints 100 for each of the candidate line maps 108, identifying the one or more peak lines 62 further includes computing respective weight values 118 of the candidate line maps 108. The weight values 118 may be computed based at least in part on numbers of peak points 54 included in those candidate line maps 108. In some examples, the one or more processing devices 12 may be configured to compute the weight values 118 as quadratic weights that are each proportional to the square of the number of peak points 54 included in the corresponding candidate line map 108. In other examples, the weight values 118 may be linearly proportional to the number of peak points 54 or may be computed according to some other function of the number of peak points 54.

Based at least in part on the weight values 118, the one or more processing devices 12 are further configured to compute a weighted mean slope 120 and a weighted slope standard deviation 122 over the candidate slopes 104 included in the candidate line maps 108. When the weighted mean slope 120 and the weighted slope standard deviation 122 are computed, the candidate slopes 104 included in each of the candidate line maps 108 may be weighted as specified by the corresponding weight value 118 of that candidate line map 108.

The one or more processing devices 12 are further configured to use the weighted mean slope 120 and the weighted slope standard deviation 122 to remove outliers from among the plurality of candidate line maps 108. Identifying the one or more peak lines 62 may further include selecting, as the one or more peak lines 62, one or more respective sets of peak points 54 included in the candidate line maps 108 that have respective candidate slopes 104 within a predefined number 124 of standard deviations from the weighted mean slope 120. The predefined number 124 of standard deviations may, for example, be two standard deviations. The one or more peak lines 62 are accordingly identified as the sets of peak points 54 included in the remaining candidate line maps 108 after the outliers have been removed. The one or more processing devices 12 are further configured to use the slopes 64 of the peak lines 62 to compute the speed change ratio 66 as discussed above with reference to FIG. 1.

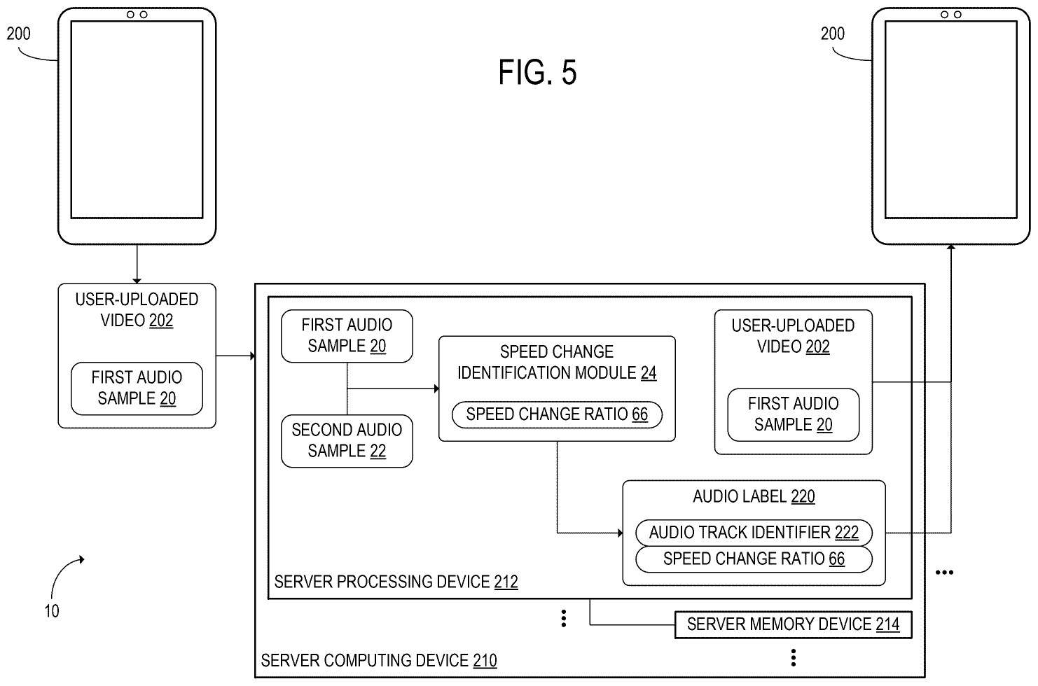

FIG. 5 schematically shows an example of the computing system 10 that includes a plurality of client computing devices 200 and one or more server computing devices 210. A client computing device 200 included among the plurality of client computing devices 200 is configured to transmit a user-uploaded video including the first audio sample 20 to the one or more server computing devices 210. The user-uploaded video 202 may be stored in one or more respective server memory devices 214 of the one or more server computing devices 210.

One or more respective server processing devices 212 of the one or more server computing devices 210 are configured to execute the speed change identification module 24 on the first audio sample 20 and a second audio sample 22 stored in the one or more server memory devices 214. The speed change identification module 24 is further configured to output the speed change ratio 66 for inclusion in an audio label 220 generated at the one or more server processing devices 212. The audio label 220 includes an audio track identifier 222 indicating that the first audio sample 20 is a variant of the second audio sample 22. The audio label 220 further includes the speed change ratio 66.

The server computing devices 210 is further configured to transmit the user-uploaded video 202, including the first audio sample 20, to another client computing device 200 along with the audio label 220. The audio label 220 may, for example, be a video annotation displayed on a graphical user interface (GUI) of the other client computing device 200 along with the user-uploaded video 202. Thus, the user of the other client computing device 200 may view information that describes the first audio sample 20 included in the user-uploaded video 202.

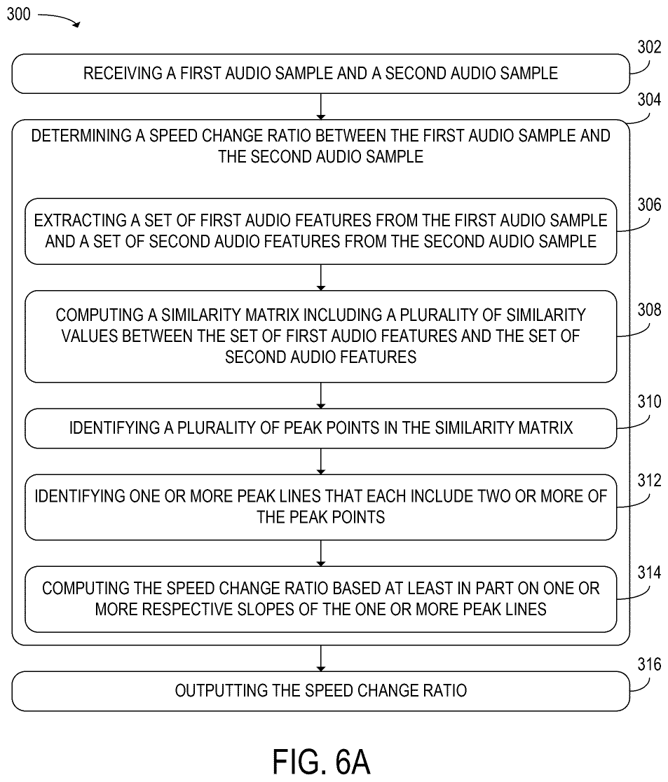

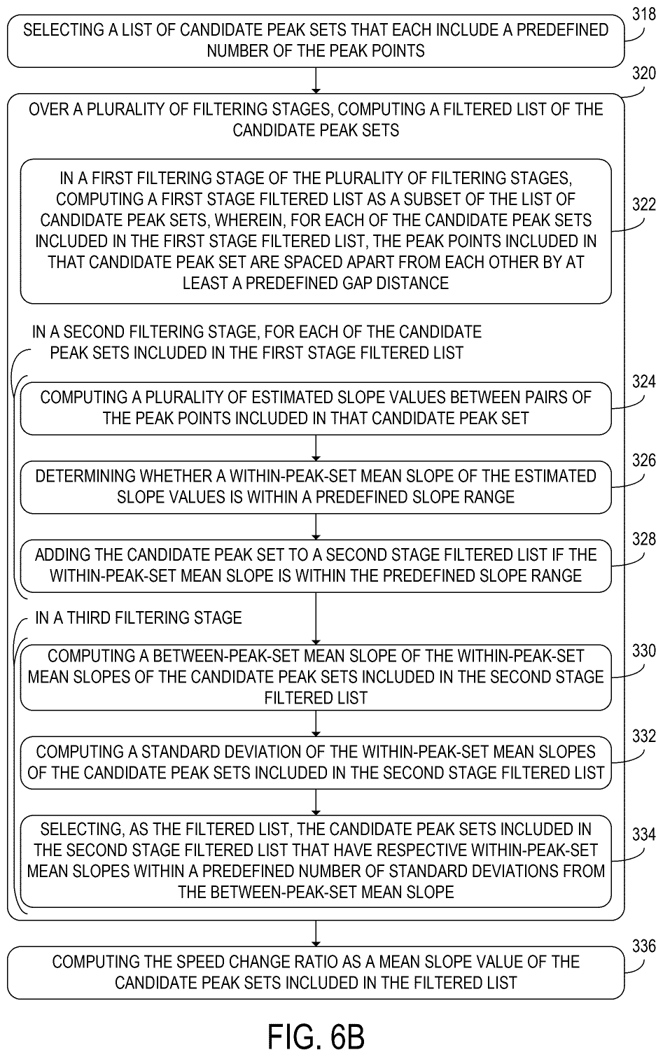

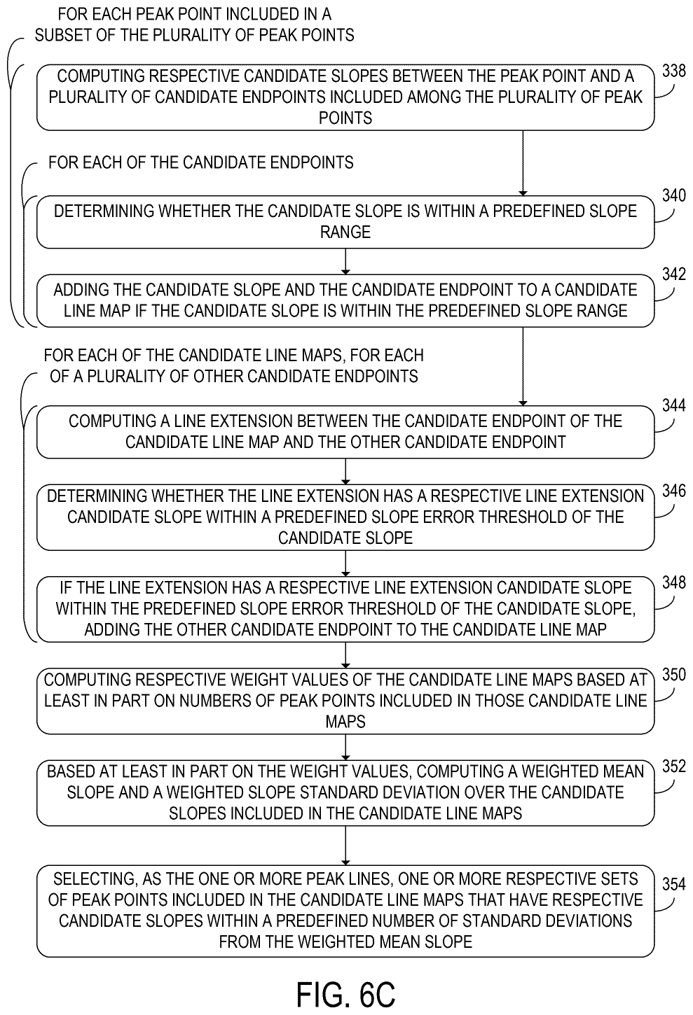

FIG. 6A shows a flowchart of a method 300 for use with a computing system to identify the speed change ratio of an audio sample. At step 302, the method 300 includes receiving a first audio sample and a second audio sample. For example, the first audio sample may be included in a user-uploaded video, and the second audio sample may be an audio sample previously stored in the memory of the computing system. The first audio sample and the second audio sample may both be music samples.

At step 304, the method 300 further includes determining a speed change ratio between the first audio sample and the second audio sample. Determining the speed change ratio at step 304 includes, at step 306, extracting a set of first audio features from the first audio sample and a set of second audio features from the second audio sample. The first audio features and the second audio features may, for example, be CQT features or VQT features. The first audio features may be associated with respective first time intervals of the first audio sample, and the second audio features may be associated with respective second time intervals of the second audio sample. In some examples, the set of first audio features and the set of second audio features are extracted from the first audio sample and the second audio sample at a feature extraction neural network. For example, the feature extraction neural network may use a CNN architecture, a transformer architecture, or a combination of CNN and transformer architectures.

At step 308, the method 300 further includes computing a similarity matrix including a plurality of similarity values between the set of first audio features and the set of second audio features. The similarity values may, for example, be cosine similarity values. The similarity matrix may include a respective similarity value for each pair of a first time interval of the first audio sample with a second time interval of the second audio sample.

At step 310, the method 300 may further include identifying a plurality of peak points in the similarity matrix. In some examples, the plurality of peak points may be selected as the K highest similarity values included in the similarity matrix, where K is a predefined peak count. For example, the highest K=150 similarity values may be selected as the peak points.

At step 312, the method 300 further includes identifying one or more peak lines that each include two or more of the peak points. The peak lines may be identified by performing multi-line fitting on the plurality of peak points.

At step 314, the method 300 further includes computing the speed change ratio based at least in part on one or more respective slopes of the one or more peak lines. For example, the speed change ratio may be computed as a mean slope over the plurality of peak lines. In some examples, the speed change ratio may be computed as a weighted mean slope over the plurality of peak lines, with the peak lines having respective weights computed based at least in part on the numbers of peak points they include.

At step 316, the method 300 further includes outputting the speed change ratio. For example, the speed change ratio may be output to a user in an audio label assigned to the first audio sample. As another example, the speed change ratio may be output to an administrator of an audio or video sharing platform.

FIG. 6B shows additional steps of the method 300 that may be performed in some examples when identifying the one or more peak lines and computing the speed change ratio. In the example of FIG. 6B, identifying the one or more peak lines includes performing a candidate peak set search. The method 300 may further include, at step 318, selecting a list of candidate peak sets that each include a predefined number of the peak points. For example, the candidate peak sets may be randomly or pseudorandomly selected from among the plurality of peak points.

At step 320, over a plurality of filtering stages, the method 300 may further include computing a filtered list of the candidate peak sets. in a first filtering stage of the plurality of filtering stages, computing the filtered list may include, at step 322, computing a first stage filtered list as a subset of the list of candidate peak sets. For each of the candidate peak sets included in the first stage filtered list, the peak points included in that candidate peak set may be spaced apart from each other by at least a predefined gap distance. The list of candidate peak sets may accordingly be filtered to exclude candidate peak sets in which the peak points are too close together to accurately reflect the structure of the similarity matrix as a whole.

Steps 324, 326, and 328 may be performed during step 320 in a second filtering stage of the plurality of filtering stages. Steps 324, 326, and 328 may be performed for each of the candidate peak sets included in the first stage filtered list. At step 324, step 320 may further include computing a plurality of estimated slope values between pairs of the peak points included in that candidate peak set. At step 326, step 320 may further include determining whether a within-peak-set mean slope of the estimated slope values is within a predefined slope range. For example, the predefined slope range may be [0.5, 2]. At step 328, step 320 may further include adding the candidate peak set to a second stage filtered list if the within-peak-set mean slope is within the predefined slope range. The second filtering stage therefore includes filtering out candidate peak sets that have estimated slope values above or below a typical range of speed change ratios.

Step 320 may further include steps 330, 332, and 334, which are performed in a third filtering stage of the plurality of filtering stages. At step 330, computing the filtered list at step 320 may further include computing a between-peak-set mean slope of the within-peak-set mean slopes of the candidate peak sets included in the second stage filtered list. At step 332, the method 300 may further include computing a standard deviation of the within-peak-set mean slopes of the candidate peak sets included in the second stage filtered list. At step 334, the method 300 may further include selecting, as the filtered list, the candidate peak sets included in the second stage filtered list that have respective within-peak-set mean slopes within a predefined number of standard deviations from the between-peak-set mean slope. For example, the predefined number of standard deviations may be 2. In the third filtering stage, step 320 accordingly includes removing outliers from the second stage filtered list.

The filtered list computed in step 320 may be used to compute the speed change ratio. At step 336, the method 300 may further include computing the speed change ratio as a mean slope value of the candidate peak sets included in the filtered list. The candidate peak sets included in the filtered list may accordingly define the peak lines that are used to compute the speed change ratio.

FIG. 6C shows steps of the method 300 that may be performed in some examples as an alternative to the steps of FIG. 6B when identifying the one or more peak lines at step 312. Steps 338, 340, and 342 of the method 300 may be performed for each peak point included in a subset of the plurality of peak points. For example, the subset may include the peak points included in a first half of a peak point ordering. In other examples, the subset may include all the peak points other than a final peak point in the ordering.

At step 338, the method 300 may further include, for each peak point included in the subset, computing respective candidate slopes between the peak point and a plurality of candidate endpoints included among the plurality of peak points. For each of the candidate endpoints, at step 340, the method 300 may further include determining whether the candidate slope is within a predefined slope range. The predefined slope range may, for example, be [0.5, 2]. At step 342, for each of the candidate endpoints, the method 300 may further include adding the candidate slope and the candidate endpoint to a candidate line map if the candidate slope is within the predefined slope range. Each candidate line map may include one or more of the peak points and one or more corresponding candidate slopes. The candidate line maps may be iteratively constructed as discussed below.

Steps 344, 346, and 348 may be performed for each of the candidate line maps associated with each of the peak points in the subset, for each of a plurality of other candidate endpoints. At step 344, the method 300 may further include computing a line extension between the candidate endpoint of the candidate line map and the other candidate endpoint. At step 346, the method 300 may further include determining whether the line extension has a respective line extension candidate slope within a predefined slope error threshold of the candidate slope. At step 348, the method 300 may further include adding the other candidate endpoint to the candidate line map if the line extension has a respective line extension candidate slope within the predefined slope error threshold of the candidate slope. Accordingly, the method further includes checking for peak points that are likely to be included in the same peak line approximated by a candidate line map. Those peak points are added to the candidate line maps if they are within the predefined slope error threshold. The method therefore includes iteratively constructing the peak lines.

At step 350, subsequently to iterating through the plurality of candidate endpoints for each of the candidate line maps, the method 300 may further include computing respective weight values of the candidate line maps based at least in part on numbers of peak points included in those candidate line maps. In some examples, the weight values are proportional to the numbers of peak points included in the candidate line maps, or to the squares of the numbers of points. At step 352, based at least in part on the weight values, the method 300 may further include computing a weighted mean slope and a weighted slope standard deviation over the candidate slopes included in the candidate line maps.

At step 354, the method 300 may further include selecting, as the one or more peak lines, one or more respective sets of peak points included in the candidate line maps that have respective candidate slopes within a predefined number of standard deviations from the weighted mean slope. The candidate line maps with outlier slope values are accordingly removed, and the respective sets of peak points included in the remaining candidate line maps are identified as the peak lines. The speed change ratio may be computed as a mean of the slopes of the identified peak lines, as in the example of FIG. 6B.

Using the systems and methods discussed above, the speed change ratio of a first audio sample relative to a second audio sample may be determined. This speed change ratio may be used to identify audio samples that are sped-up or slowed-down versions of other audio samples. These speed-modified audio samples may be detected, for example, in order to programmatically generate music track labels or detect copyright infringement. In contrast to previous speed change detection methods that utilize audio fingerprinting, the systems and methods discussed above may allow for accurate identification of the speed change ratio even in examples in which other modifications, such as remixing a song or changing its singer, are also applied to an audio sample. The systems and methods discussed above therefore provide a robust and flexible approach to speed-modified audio sample identification.

The methods and processes described herein are tied to a computing system of one or more computing devices. In particular, such methods and processes can be implemented as a computer-application program or service, an application-programming interface (API), a library, and/or other computer-program product.

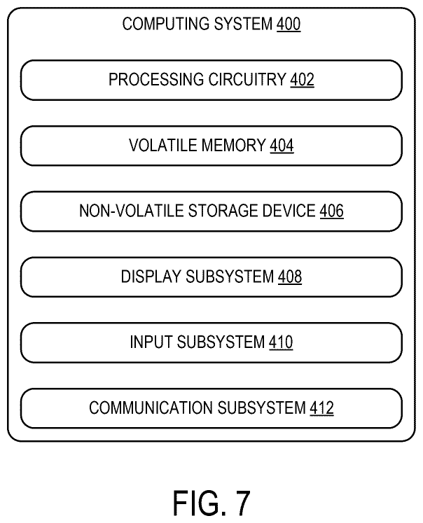

FIG. 7 schematically shows a non-limiting embodiment of a computing system 400 that can enact one or more of the methods and processes described above. Computing system 400 is shown in simplified form. Computing system 400 may embody the computing system 10 described above and illustrated in FIG. 1. Components of computing system 400 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 400 includes processing circuitry 402, volatile memory 404, and a non-volatile storage device 406. Computing system 400 may optionally include a display subsystem 408, input subsystem 410, communication subsystem 412, and/or other components not shown in FIG. 7.

Processing circuitry 402 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 402 may be single-core or multi-core, and the instructions executed thereon may be configured for sequential, parallel, and/or distributed processing. Individual components of the processing circuitry 402 optionally may be distributed among two or more separate devices, which may be remotely located and/or configured for coordinated processing. For example, aspects of the computing system 400 disclosed herein may be virtualized and executed by remotely accessible, networked computing devices configured in a cloud-computing configuration. In such a case, these virtualized aspects are run on different physical logic processors of various different machines. These different physical logic processors of the different machines will be understood to be collectively encompassed by processing circuitry 402.

Non-volatile storage device 406 includes one or more physical devices configured to hold instructions executable by the processing circuitry 402 to implement the methods and processes described herein. When such methods and processes are implemented, the state of non-volatile storage device 406 may be transformed—e.g., to hold different data.

Non-volatile storage device 406 may include physical devices that are removable and/or built in. Non-volatile storage device 406 may include optical memory, semiconductor memory, and/or magnetic memory, or other mass storage device technology. Non-volatile storage device 406 may include nonvolatile, dynamic, static, read/write, read-only, sequential-access, location-addressable, file-addressable, and/or content-addressable devices. It will be appreciated that non-volatile storage device 406 is configured to hold instructions even when power is cut to the non-volatile storage device 406.

Volatile memory 404 may include physical devices that include random access memory. Volatile memory 404 is typically utilized by processing circuitry 402 to temporarily store information during processing of software instructions. It will be appreciated that volatile memory 404 typically does not continue to store instructions when power is cut to the volatile memory 404.

Aspects of processing circuitry 402, volatile memory 404, and non-volatile storage device 406 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 400 typically implemented in software by a processor to perform a particular function using portions of volatile memory, which function involves transformative processing that specially configures the processor to perform the function. Thus, a module, program, or engine may be instantiated via processing circuitry 402 executing instructions held by non-volatile storage device 406, using portions of volatile memory 404. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 408 may be used to present a visual representation of data held by non-volatile storage device 406. The visual representation may take the form of a graphical user interface (GUI). As the herein described methods and processes change the data held by the non-volatile storage device, and thus transform the state of the non-volatile storage device, the state of display subsystem 408 may likewise be transformed to visually represent changes in the underlying data. Display subsystem 408 may include one or more display devices utilizing virtually any type of technology. Such display devices may be combined with processing circuitry 402, volatile memory 404, and/or non-volatile storage device 406 in a shared enclosure, or such display devices may be peripheral display devices.

When included, input subsystem 410 may comprise or interface with one or more user-input devices such as a keyboard, mouse, touch screen, camera, or microphone.

When included, communication subsystem 412 may be configured to communicatively couple various computing devices described herein with each other, and with other devices. Communication subsystem 412 may include wired and/or wireless communication devices compatible with one or more different communication protocols. As non-limiting examples, the communication subsystem 412 may be configured for communication via a wired or wireless local- or wide-area network, broadband cellular network, etc. In some embodiments, the communication subsystem may allow computing system 400 to send and/or receive messages to and/or from other devices via a network such as the Internet.

The following paragraphs provide additional description of the subject matter of the present disclosure. According to one aspect of the present disclosure, a computing system is provided, including one or more processing devices configured to receive a first audio sample and a second audio sample. The one or more processing devices are further configured to determine a speed change ratio between the first audio sample and the second audio sample at least in part by extracting a set of first audio features from the first audio sample and a set of second audio features from the second audio sample. Determining the speed change ratio further includes computing a similarity matrix including a plurality of similarity values between the set of first audio features and the set of second audio features. Determining the speed change ratio further includes identifying a plurality of peak points in the similarity matrix. Determining the speed change ratio further includes identifying one or more peak lines that each include two or more of the peak points. Determining the speed change ratio further includes computing the speed change ratio based at least in part on one or more respective slopes of the one or more peak lines. The one or more processing devices are further configured to output the speed change ratio. The above features may have the technical effect of determining a speed change ratio between the first and second audio samples.

According to this aspect, the one or more processing devices may be configured to extract the set of first audio features and the set of second audio features at a feature extraction neural network. The above features may have the technical effect of obtaining sets of audio features such as CQT or VQT features.

According to this aspect, the one or more processing devices may be configured to identify the plurality of peak points as the K highest similarity values included in the similarity matrix, where K is a predefined peak count. The above features may have the technical effect of identifying peaks in the similarity matrix.

According to this aspect, the one or more processing devices are configured to identify the one or more peak lines at least in part by selecting a list of candidate peak sets that each include a predefined number of the peak points. Identifying the one or more peak lines may further include computing a filtered list of the candidate peak sets over a plurality of filtering stages. The one or more processing devices may be further configured to compute the speed change ratio as a mean slope value of the candidate peak sets included in the filtered list. The above features may have the technical effect of identifying lines of peaks in the similarity matrix and computing the speed change ratio from the slopes of those lines.

According to this aspect, computing the filtered list may include, in a first filtering stage of the plurality of filtering stages, computing a first stage filtered list as a subset of the list of candidate peak sets. For each of the candidate peak sets included in the first stage filtered list, the peak points included in that candidate peak set may be spaced apart from each other by at least a predefined gap distance. The above features may have the technical effect of excluding candidate peak sets in which the peak points are too close together to accurately reflect the structure of the similarity matrix as a whole.

According to this aspect, in a second filtering stage of the plurality of filtering stages, computing the filtered list may further include, for each of the candidate peak sets included in the first stage filtered list, computing a plurality of estimated slope values between pairs of the peak points included in that candidate peak set. Computing the filtered list may further include determining whether a within-peak-set mean slope of the estimated slope values is within a predefined slope range. Computing the filtered list may further include adding the candidate peak set to a second stage filtered list if the within-peak-set mean slope is within the predefined slope range. The above features may have the technical effect of filtering out candidate peak sets that have within-peak-set mean slopes that are very high or very low.

According to this aspect, in a third filtering stage of the plurality of filtering stages, computing the filtered list may further include computing a between-peak-set mean slope of the within-peak-set mean slopes of the candidate peak sets included in the second stage filtered list. Computing the filtered list may further include computing a standard deviation of the within-peak-set mean slopes of the candidate peak sets included in the second stage filtered list. Computing the filtered list may further include selecting, as the filtered list, the candidate peak sets included in the second stage filtered list that have respective within-peak-set mean slopes within a predefined number of standard deviations from the between-peak-set mean slope. The above features may have the technical effect of filtering out candidate peak sets that have outlier within-peak-set mean slope values.

According to this aspect, the one or more processing devices may be configured to identify the one or more peak lines at least in part by, for each peak point included in a subset of the plurality of peak points, computing respective candidate slopes between the peak point and a plurality of candidate endpoints included among the plurality of peak points. Identifying the one or more peak lines may further include, for each of the candidate endpoints, determining whether the candidate slope is within a predefined slope range and adding the candidate slope and the candidate endpoint to a candidate line map if the candidate slope is within the predefined slope range. The above features may have the technical effect of computing peak lines within the similarity matrix.

According to this aspect, identifying the one or more peak lines may further include, for each of the candidate line maps, for each of a plurality of other candidate endpoints, computing a line extension between the candidate endpoint of the candidate line map and the other candidate endpoint. Identifying the one or more peak lines may further include determining whether the line extension has a respective line extension candidate slope within a predefined slope error threshold of the candidate slope. Identifying the one or more peak lines may further include adding the other candidate endpoint to the candidate line map if the line extension has a respective line extension candidate slope within the predefined slope error threshold of the candidate slope. The above features may have the technical effect of checking candidate extensions of the candidate line maps when identifying the peak lines.

According to this aspect, subsequently to iterating through the plurality of candidate endpoints for each of the candidate line maps, identifying the one or more peak lines may further include computing respective weight values of the candidate line maps based at least in part on numbers of peak points included in those candidate line maps. Identifying the one or more peak lines may further include, based at least in part on the weight values, computing a weighted mean slope and a weighted slope standard deviation over the candidate slopes included in the candidate line maps. Identifying the one or more peak lines may further include selecting, as the one or more peak lines, one or more respective sets of peak points included in the candidate line maps that have respective candidate slopes within a predefined number of standard deviations from the weighted mean slope. The above features may have the technical effect of applying different weights to the candidate line maps when identifying the peak lines, in order to account for differences in sample size among the candidate line maps.

According to another aspect of the present disclosure, a method for use with a computing system is provided. The method includes receiving a first audio sample and a second audio sample. The method further includes determining a speed change ratio between the first audio sample and the second audio sample at least in part by extracting a set of first audio features from the first audio sample and a set of second audio features from the second audio sample. Determining the speed change ratio further includes computing a similarity matrix including a plurality of similarity values between the set of first audio features and the set of second audio features. Determining the speed change ratio further includes identifying a plurality of peak points in the similarity matrix. Determining the speed change ratio further includes identifying one or more peak lines that each include two or more of the peak points. Determining the speed change ratio further includes computing the speed change ratio based at least in part on one or more respective slopes of the one or more peak lines. The method further includes outputting the speed change ratio. The above features may have the technical effect of determining a speed change ratio between the first and second audio samples.

According to this aspect, the set of first audio features and the set of second audio features may be extracted from the first audio sample and the second audio sample at a feature extraction neural network. The above features may have the technical effect of obtaining sets of audio features such as CQT or VQT features.

According to this aspect, identifying the one or more peak lines may include selecting a list of candidate peak sets that each include a predefined number of the peak points. Identifying the one or more peak lines may further include, over a plurality of filtering stages, computing a filtered list of the candidate peak sets. The method may further include computing the speed change ratio as a mean slope value of the candidate peak sets included in the filtered list. The above features may have the technical effect of identifying lines of peaks in the similarity matrix and computing the speed change ratio from the slopes of those lines.

According to this aspect, computing the filtered list may include, in a first filtering stage of the plurality of filtering stages, computing a first stage filtered list as a subset of the list of candidate peak sets. For each of the candidate peak sets included in the first stage filtered list, the peak points included in that candidate peak set may be spaced apart from each other by at least a predefined gap distance. The above features may have the technical effect of excluding candidate peak sets in which the peak points are too close together to accurately reflect the structure of the similarity matrix as a whole.

According to this aspect, in a second filtering stage of the plurality of filtering stages, computing the filtered list further may include, for each of the candidate peak sets included in the first stage filtered list, computing a plurality of estimated slope values between pairs of the peak points included in that candidate peak set. Computing the filtered list may further include determining whether a within-peak-set mean slope of the estimated slope values is within a predefined slope range. Computing the filtered list may further include adding the candidate peak set to a second stage filtered list if the within-peak-set mean slope is within the predefined slope range. The above features may have the technical effect of filtering out candidate peak sets that have within-peak-set mean slopes that are very high or very low.

According to this aspect, in a third filtering stage of the plurality of filtering stages, computing the filtered list may further include computing a between-peak-set mean slope of the within-peak-set mean slopes of the candidate peak sets included in the second stage filtered list. Computing the filtered list may further include computing a standard deviation of the within-peak-set mean slopes of the candidate peak sets included in the second stage filtered list. Computing the filtered list may further include selecting, as the filtered list, the candidate peak sets included in the second stage filtered list that have respective within-peak-set mean slopes within a predefined number of standard deviations from the between-peak-set mean slope. The above features may have the technical effect of filtering out candidate peak sets that have outlier within-peak-set mean slope values.

According to this aspect, identifying the one or more peak lines may include, for each peak point included in a subset of the plurality of peak points, computing respective candidate slopes between the peak point and a plurality of candidate endpoints included among the plurality of peak points. For each of the candidate endpoints, identifying the one or more peak lines may further include determining whether the candidate slope is within a predefined slope range, and, if the candidate slope is within the predefined slope range, adding the candidate slope and the candidate endpoint to a candidate line map. The above features may have the technical effect of computing peak lines within the similarity matrix.

According to this aspect, identifying the one or more peak lines may further include, for each of the candidate line maps, for each of a plurality of other candidate endpoints, computing a line extension between the candidate endpoint of the candidate line map and the other candidate endpoint. Identifying the one or more peak lines may further include determining whether the line extension has a respective line extension candidate slope within a predefined slope error threshold of the candidate slope. Identifying the one or more peak lines may further include adding the other candidate endpoint to the candidate line map if the line extension has a respective line extension candidate slope within the predefined slope error threshold of the candidate slope. The above features may have the technical effect of checking candidate extensions of the candidate line maps when identifying the peak lines.

According to this aspect, subsequently to iterating through the plurality of candidate endpoints for each of the candidate line maps, identifying the one or more peak lines may further include computing respective weight values of the candidate line maps based at least in part on numbers of peak points included in those candidate line maps. Identifying the one or more peak lines may further include, based at least in part on the weight values, computing a weighted mean slope and a weighted slope standard deviation over the candidate slopes included in the candidate line maps. Identifying the one or more peak lines may further include selecting, as the one or more peak lines, one or more respective sets of peak points included in the candidate line maps that have respective candidate slopes within a predefined number of standard deviations from the weighted mean slope. The above features may have the technical effect of applying different weights to the candidate line maps when identifying the peak lines, in order to account for differences in sample size among the candidate line maps.

According to another aspect of the present disclosure, a computing system is provided, including one or more processing devices configured to receive a first audio sample and a second audio sample. The one or more processing devices are further configured to determine a speed change ratio between the first audio sample and the second audio sample at least in part by, at a feature extraction neural network, extracting a set of first audio features from the first audio sample and a set of second audio features from the second audio sample. Determining the speed change ratio further includes computing a similarity matrix including a plurality of similarity values between the set of first audio features and the set of second audio features. Determining the speed change ratio further includes identifying a plurality of peak points in the similarity matrix. Determining the speed change ratio further includes identifying one or more peak lines that each include two or more of the peak points. Determining the speed change ratio further includes computing the speed change ratio as a mean of one or more respective slopes of the one or more peak lines. The one or more processing devices are further configured to output the speed change ratio. The above features may have the technical effect of determining a speed change ratio between the first and second audio samples.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
receive a first audio sample and a second audio sample;
determine a speed change ratio between the first audio sample and the second audio sample at least in part by:
extracting a set of first audio features from the first audio sample and a set of second audio features from the second audio sample;
computing a similarity matrix including a plurality of similarity values between the set of first audio features and the set of second audio features;
identifying a plurality of peak points in the similarity matrix;
identifying one or more peak lines that each include two or more of the peak points; and
computing the speed change ratio based at least in part on one or more respective slopes of the one or more peak lines; and
output the speed change ratio.

2. The computing system of claim 1, wherein the one or more processing devices are configured to extract the set of first audio features and the set of second audio features at a feature extraction neural network.

3. The computing system of claim 1, wherein the one or more processing devices are configured to identify the plurality of peak points as the K highest similarity values included in the similarity matrix, where K is a predefined peak count.

4. The computing system of claim 1, wherein the one or more processing devices are configured to:
identify the one or more peak lines at least in part by:
selecting a list of candidate peak sets that each include a predefined number of the peak points; and
over a plurality of filtering stages, computing a filtered list of the candidate peak sets; and
compute the speed change ratio as a mean slope value of the candidate peak sets included in the filtered list.

5. The computing system of claim 4, wherein:
computing the filtered list includes, in a first filtering stage of the plurality of filtering stages, computing a first stage filtered list as a subset of the list of candidate peak sets; and
for each of the candidate peak sets included in the first stage filtered list, the peak points included in that candidate peak set are spaced apart from each other by at least a predefined gap distance.

6. The computing system of claim 5, wherein, in a second filtering stage of the plurality of filtering stages, computing the filtered list further includes, for each of the candidate peak sets included in the first stage filtered list:
computing a plurality of estimated slope values between pairs of the peak points included in that candidate peak set;
determining whether a within-peak-set mean slope of the estimated slope values is within a predefined slope range; and
adding the candidate peak set to a second stage filtered list if the within-peak-set mean slope is within the predefined slope range.

7. The computing system of claim 6, wherein, in a third filtering stage of the plurality of filtering stages, computing the filtered list further includes:
computing a between-peak-set mean slope of the within-peak-set mean slopes of the candidate peak sets included in the second stage filtered list;
computing a standard deviation of the within-peak-set mean slopes of the candidate peak sets included in the second stage filtered list; and
selecting, as the filtered list, the candidate peak sets included in the second stage filtered list that have respective within-peak-set mean slopes within a predefined number of standard deviations from the between-peak-set mean slope.

8. The computing system of claim 1, wherein the one or more processing devices are configured to identify the one or more peak lines at least in part by, for each peak point included in a subset of the plurality of peak points:
computing respective candidate slopes between the peak point and a plurality of candidate endpoints included among the plurality of peak points; and
for each of the candidate endpoints:
determining whether the candidate slope is within a predefined slope range; and
adding the candidate slope and the candidate endpoint to a candidate line map if the candidate slope is within the predefined slope range.

9. The computing system of claim 8, wherein identifying the one or more peak lines further includes, for each of the candidate line maps, for each of a plurality of other candidate endpoints:
computing a line extension between the candidate endpoint of the candidate line map and the other candidate endpoint;
determining whether the line extension has a respective line extension candidate slope within a predefined slope error threshold of the candidate slope; and
if the line extension has a respective line extension candidate slope within the predefined slope error threshold of the candidate slope, adding the other candidate endpoint to the candidate line map.

10. The computing system of claim 9, wherein, subsequently to iterating through the plurality of candidate endpoints for each of the candidate line maps, identifying the one or more peak lines further includes:
computing respective weight values of the candidate line maps based at least in part on numbers of peak points included in those candidate line maps;
based at least in part on the weight values, computing a weighted mean slope and a weighted slope standard deviation over the candidate slopes included in the candidate line maps; and
selecting, as the one or more peak lines, one or more respective sets of peak points included in the candidate line maps that have respective candidate slopes within a predefined number of standard deviations from the weighted mean slope.

11. A method for use with a computing system, the method comprising:
receiving a first audio sample and a second audio sample;
determining a speed change ratio between the first audio sample and the second audio sample at least in part by:
extracting a set of first audio features from the first audio sample and a set of second audio features from the second audio sample;
computing a similarity matrix including a plurality of similarity values between the set of first audio features and the set of second audio features;
identifying a plurality of peak points in the similarity matrix;
identifying one or more peak lines that each include two or more of the peak points; and
computing the speed change ratio based at least in part on one or more respective slopes of the one or more peak lines; and
outputting the speed change ratio.

12. The method of claim 11, wherein the set of first audio features and the set of second audio features are extracted from the first audio sample and the second audio sample at a feature extraction neural network.

13. The method of claim 11, wherein:
identifying the one or more peak lines includes:
selecting a list of candidate peak sets that each include a predefined number of the peak points; and
over a plurality of filtering stages, computing a filtered list of the candidate peak sets; and
computing the speed change ratio as a mean slope value of the candidate peak sets included in the filtered list.

14. The method of claim 13, wherein:
computing the filtered list includes, in a first filtering stage of the plurality of filtering stages, computing a first stage filtered list as a subset of the list of candidate peak sets; and
for each of the candidate peak sets included in the first stage filtered list, the peak points included in that candidate peak set are spaced apart from each other by at least a predefined gap distance.

15. The method of claim 14, wherein, in a second filtering stage of the plurality of filtering stages, computing the filtered list further includes, for each of the candidate peak sets included in the first stage filtered list:
computing a plurality of estimated slope values between pairs of the peak points included in that candidate peak set;
determining whether a within-peak-set mean slope of the estimated slope values is within a predefined slope range; and
adding the candidate peak set to a second stage filtered list if the within-peak-set mean slope is within the predefined slope range.

16. The method of claim 15, wherein, in a third filtering stage of the plurality of filtering stages, computing the filtered list further includes:
computing a between-peak-set mean slope of the within-peak-set mean slopes of the candidate peak sets included in the second stage filtered list;
computing a standard deviation of the within-peak-set mean slopes of the candidate peak sets included in the second stage filtered list; and
selecting, as the filtered list, the candidate peak sets included in the second stage filtered list that have respective within-peak-set mean slopes within a predefined number of standard deviations from the between-peak-set mean slope.

17. The method of claim 11, wherein identifying the one or more peak lines includes, for each peak point included in a subset of the plurality of peak points:
computing respective candidate slopes between the peak point and a plurality of candidate endpoints included among the plurality of peak points; and
for each of the candidate endpoints:
determining whether the candidate slope is within a predefined slope range; and
adding the candidate slope and the candidate endpoint to a candidate line map if the candidate slope is within the predefined slope range.

18. The method of claim 17, wherein identifying the one or more peak lines further includes, for each of the candidate line maps, for each of a plurality of other candidate endpoints:
computing a line extension between the candidate endpoint of the candidate line map and the other candidate endpoint;
determining whether the line extension has a respective line extension candidate slope within a predefined slope error threshold of the candidate slope; and
if the line extension has a respective line extension candidate slope within the predefined slope error threshold of the candidate slope, adding the other candidate endpoint to the candidate line map.

19. The method of claim 18, wherein, subsequently to iterating through the plurality of candidate endpoints for each of the candidate line maps, identifying the one or more peak lines further includes:
computing respective weight values of the candidate line maps based at least in part on numbers of peak points included in those candidate line maps;
based at least in part on the weight values, computing a weighted mean slope and a weighted slope standard deviation over the candidate slopes included in the candidate line maps; and
selecting, as the one or more peak lines, one or more respective sets of peak points included in the candidate line maps that have respective candidate slopes within a predefined number of standard deviations from the weighted mean slope.

20. A computing system comprising:
one or more processing devices configured to:
receive a first audio sample and a second audio sample;
determine a speed change ratio between the first audio sample and the second audio sample at least in part by:
at a feature extraction neural network, extracting a set of first audio features from the first audio sample and a set of second audio features from the second audio sample;
computing a similarity matrix including a plurality of similarity values between the set of first audio features and the set of second audio features;
identifying a plurality of peak points in the similarity matrix;
identifying one or more peak lines that each include two or more of the peak points; and
computing the speed change ratio as a mean of one or more respective slopes of the one or more peak lines; and
output the speed change ratio.
